(19) United States
(12) Patent Application Publication
(10) Pub. No.: US 2002/0021830 A1
(43) Pub. Date: Feb. 21, 2002

(54) Interrupted treatment quality assurance

(76) Inventor: Daniel M. Ritt, Colorado Springs, CO (US)

Correspondence Address: Matthew J. Russo, Rader, Fishman & Grauer PLLC, Suite 140, 383 Inverness Drive South, Englewood, CO, 80112, US

(21) Appl. No.: 09/932,347

(22) Filed: Aug. 17, 2001

Related U.S. Application Data
(60) Provisional application No. 60/225,910, filed on Aug. 17, 2000.

(51) Int. Cl. G06K 9/00; G06K 9/32

(52) U.S. Cl. 382/132; 382/294

(57) ABSTRACT

Methods, devices and systems for performing quality assurance on an interrupted radiotherapy treatment are disclosed. The method includes measuring a first delivered dose distribution of an uninterrupted treatment, measuring a second delivered dose distribution of the same treatment that has been interrupted, and obtaining first and second images that represent the first and second delivered dose distributions, respectively. The method includes registering the first and second images so that they are mapped into the same physical space, and comparing the first and second images to determine any differences between the two images and hence any differences between the uninterrupted and the interrupted radiation treatments. The methods are useful in discerning the affects of system interruption on complex conformal radiation therapies, including IMRT.

### CROSS-REFERENCE TO RELATED APPLICATION

This application claims the benefit of U.S. Provisional Application No. 60/225,910, filed Aug. 17, 2000.

### BACKGROUND OF THE INVENTION

1. Field of the Invention

The present invention relates to radiation therapy systems, and more particularly, to methods and devices for verifying radiation treatment subject to interruption.

2. Discussion

Recent improvements in radiation therapy promise improved tumor destruction while reducing damage to adjacent tissues. Such techniques, which include static and dynamic intensity modulated radiation therapy (IMRT), tomotherapy, and arc therapy using uniform or variable intensity beams, are known as conformal radiation therapies. Each therapy employs a radiation source external to the patient's body. The radiation source produces a radiation field having a shape that substantially conforms to a two-dimensional outline of the target volume—i.e., a region in a patient's body (e.g., tumor) that receives a prescribed radiation dose. Conformal radiation therapies such as IMRT, seek higher cure rates than conventional uniform external beam techniques by increasing the radiation dose delivered to the patient while minimizing deleterious radiation dosing of normal tissues. For a discussion of conformal radiation therapies, including intensity modulated radiation therapy, arc therapy, and tomotherapy, see U.S. Pat. No. 6,038,283 issued to Carol et al., U.S. Pat. No. 5,818,902 issued to Yu, and U.S. Pat. No. 5,647,663 issued to Holmes, which are herein incorporated by reference in their entirety and for all purposes.

FIG. 1 shows a typical radiation therapy system 10 for use in IMRT treatment and other conformal radiation therapies. The system 10 employs a linear accelerator 12 as the radiation source. The linear accelerator 12 includes a treatment head 14 that projects outward from a gantry 16. The gantry 16 is rotatably mounted on a housing 18 that contains hardware (not shown) for controlling, among other things, the movement of the gantry 16 about a rotation axis 20. The linear accelerator 12 includes a beam-shielding device, such as a multi-leaf collimator 22 (MLC), which shapes the radiation beam (ionizing radiation) emerging from the linear accelerator's beam delivery system (not shown). The beam delivery system varies among manufacturers, but typically includes an electron gun, an accelerator waveguide, a bending magnet assembly, target and flattening filters, ionization chambers, and a primary collimator. For a detailed description of linear accelerators, see Metcalfe et al., The Physics of Radiotherapy X-Rays from Linear Accelerators, 1-37 (1997), which is herein incorporated by reference in its entirety for all purposes.

During treatment, the patient (not shown) is secured to a treatment couch 24, which comprises a table 26, which can translate along positioning rails 28 mounted on a base 30. The positioning rails 28 allow the table 26 to move independently of the base 30, in either lateral (side-to-side) or longitudinal directions. The base 30 includes a lift mechanism for adjusting the height of the table 26, and a bearing mechanism, which permits rotation of the couch 24 about an axis 32 normal to the table 26 surface 34. The resulting angle between the treatment couch 24 and the rotation axis 20 of the gantry 16 is known as the couch angle. The radiation therapy system 10 shown in FIG. 1 also includes a removable phantom 36 that may be used to develop a calibration that relates the response of a detection medium to absorbed dose. The calibration is then used to measure or predict the absorbed dose in various tissues of the patient that will undergo radiotherapy. The phantom 36 includes a radiographic film 38 (detection medium) that darkens upon exposure to ionizing radiation, which is sandwiched between layers 40 of material that mimic the response of human tissue to ionizing radiation.

For IMRT treatment, the shaped beam exiting the multi-leaf collimator 22 is a bundle of smaller, finite size pencil beams, each having a cross-sectional area of about one square centimeter, but generally differing in intensity. The shaped beam, which is represented by a group of rays 42 in FIG. 1, strikes the target volume along an axis 44 of the shaped beam 42. The target volume is located at what is known as the isocenter, which is the defined as the intersection of the axes 20, 32 of rotation of the gantry 16 and the treatment couch 24 and the axis 44 of the shaped beam 42. Most radiation therapy systems employ electron or photon radiation, but may use any detectable ionizing radiation, including proton and neutron radiation.

The radiation therapy system 10 also includes a computer-based control system (not shown), which is usually housed at a remote location from the linear accelerator 12 and the treatment couch 24 of FIG. 1. The control system may comprise a computer workstation, which includes a central processing unit (CPU) that communicates with read-only memory, random access memory or both. Typically, computer instructions and data for controlling the radiation therapy system 10 are loaded into memory from a storage device or computer readable medium, which may be physically located within the workstation or at a remote server location. To interact with the radiation therapy system 10, the control system may include one or more visual display units or monitors, and a device for inputting data, including a keyboard or a pointing device, such as a pressure-sensitive stylus, touch pad, mouse or trackball. Ideally, the workstation includes a graphical user interface through which a therapist (operator) interacts with software that controls the radiation therapy system 10. For a discussion of graphical user interfaces for use with a radiation therapy system, see U.S. Pat. No. 6,222,544 issued to Tarr et al., which is herein incorporated by reference in its entirety and for all purposes.

Prior to a patient undergoing radiation therapy, a radiation physicist develops a treatment plan, which is a set of instructions that the therapist enters into the control system of the radiation therapy system 10 of FIG. 1. The treatment plan takes into account numerous factors that affect the efficacy of radiation therapy including the location and shape of the tumor, the resulting target volume, and the presence of anatomical structures adjacent to the target volume that may influence or constrain the requisite dose distribution. For conformal radiation therapies such as IMRT, the treatment plan is complex, typically specifying beam 42 intensity levels, MLC 22 leaf positions, and the positions of the beam axis (gantry 16 angle) and couch angle, etc. as functions of time.

During IMRT and other complex radiation therapy treatments it is not uncommon for the treatment to be interrupted. Typical reasons for interruptions include patient discomfort or illness (nausea, breathing difficulty, and the like), transitory power failure due to nearby lightening strikes, equipment malfunction, hospital emergencies, and so on. Several radiation therapy systems provide for resumption of radiation treatment following such interruptions. For example, when a treatment is interrupted, the computer-based control system may notify the therapist via a message on the monitor that the treatment was interrupted or stopped at a particular time or step of the treatment The therapist has the option of terminating the treatment session or informing the control system through a keystroke or mouse click to resume the treatment by inputting the time or step when the treatment was interrupted. The radiation therapy system 10 then repeats the treatment plan from the beginning, but holds the beam off—i.e., directs the beam 42 away from the patient—until the treatment plan reaches the interruption point. After it reaches the interruption point, the system 10 resumes administering radiation to the patient in accordance with the treatment plan.

Because the treatment plans are complex, it is difficult to perform quality assurance tests to verify proper operation of the equipment when a treatment has been interrupted one or more times. In the past, radiation physicists, therapists, and physicians have had to rely on the assurances of radiotherapy system manufacturers that interruptions do not substantially affect the patient's treatment plan. Therefore, what is needed is a quality system for ensuring integrity of the treatment following one or more system interruptions.

### SUMMARY OF THE INVENTION

The present invention provides methods and devices for ensuring that one or more interruptions during radiation therapy does not substantially affect the desired treatment plan. The present invention is particularly useful for determining the affect of an interruption on complex conformal radiation therapies, including static and dynamic intensity modulated radiation therapy (IMRT), tomotherapy, and arc therapy using uniform or variable intensity beams.

One aspect of the present invention provides a method of performing quality assurance on a radiation treatment that has been interrupted one or more times. The method includes measuring a first delivered dose distribution of an uninterrupted treatment, measuring a second delivered dose distribution of an interrupted treatment, and obtaining first and second images that represent the first and second delivered dose distributions, respectively. The method also includes registering the first and second images so that they can be mapped into the same physical space, and comparing the first and second images to determine any differences between the two images and thus any differences between the uninterrupted and the interrupted radiation treatments. The method optionally includes displaying or outputting a quality characteristic that indicates differences between the uninterrupted and the interrupted treatments.

Another aspect of the present invention provides a device for performing quality assurance on an interrupted radiation treatment. The device comprises a software routine that is tangibly embodied on a computer-readable medium and is configured to generate a quality characteristic indicating differences between an uninterrupted treatment and an interrupted treatment. The software routine generates the quality characteristic from first and second images, which are derived, respectively, from measurements of a first delivered dose distribution obtained during an uninterrupted treatment and a second delivered dose distribution obtained during an interrupted treatment.

Still another aspect of the present invention provides a system for performing quality assurance on an interrupted radiation treatment. The system includes a computer having a graphical user interface that enables a user to interact with a software routine running on the computer. The software routine is configured to generate a quality characteristic that indicates differences between an uninterrupted treatment and an interrupted treatment. The software routine generates the quality characteristic from first and second images, the first and second images derived, respectively, from measurements of a first delivered dose distribution obtained during an uninterrupted treatment and a second delivered dose distribution obtained during an interrupted treatment.

### BRIEF DESCRIPTION OF THE DRAWINGS

FIG. 1 shows a typical radiation therapy system for use in IMRT treatment and other conformal radiation therapies.

FIG. 2 shows a method of performing quality assurance on a radiation treatment that has been interrupted one or more times.

FIG. 3 shows a first image of a test pattern generated by exposing a radiographic film to radiation from a linear accelerator that was uninterrupted during exposure of the test pattern.

FIG. 4 shows a second image of a test pattern generated by exposing a radiographic film to radiation from the same linear accelerator as the first image, except that the linear accelerator was interrupted during exposure of the test pattern.

FIG. 5 shows an image obtained by subtracting the first image from the second image.

### DETAILED DESCRIPTION

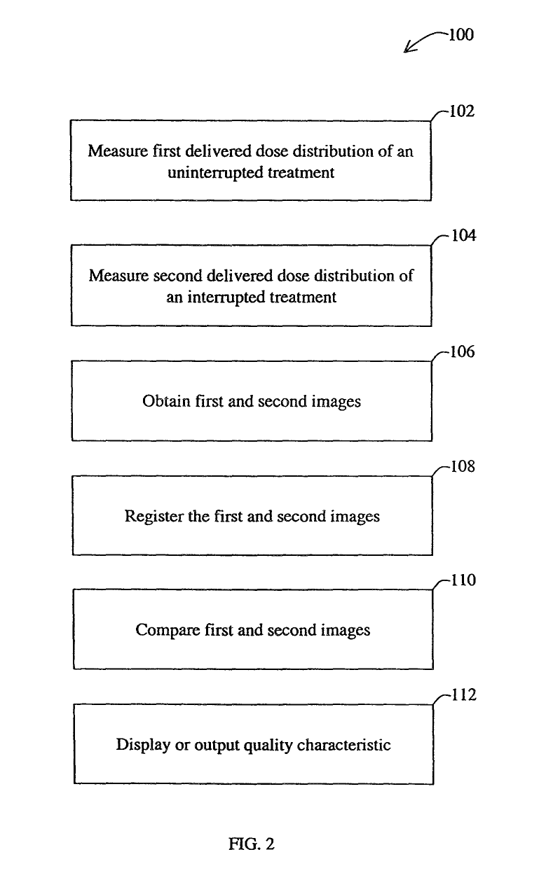

FIG. 2 illustrates a method 100 of performing quality assurance (QA) on a radiation treatment that has been interrupted one or more times. The method 100 includes measuring 102 a first delivered dose distribution of an uninterrupted treatment, measuring 104 a second delivered dose distribution of the same treatment plan which has been interrupted, and obtaining 106 first and second images that represent the first and second delivered dose distributions, respectively. The method 100 also includes registering 108 the first and second images so that they are mapped into the same physical space, and comparing 110 the first and second images to determine any differences between the two images and hence any differences between the uninterrupted and the interrupted radiation treatments. Finally, the method 100 optionally displays 112 or outputs a quality characteristic that indicates any differences between the uninterrupted and the interrupted treatments.

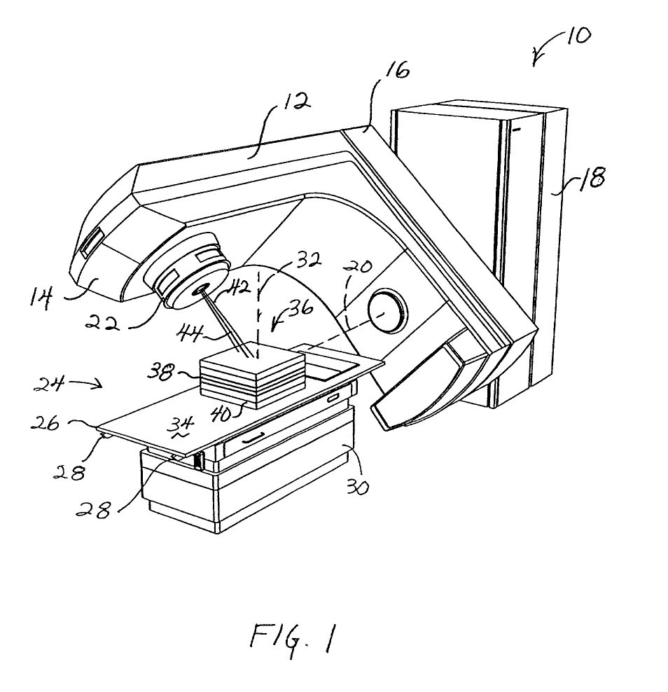

Many techniques are available for measuring 102, 104 the first and second delivered dose distributions. Suitable techniques include exposing a detection medium to radiation from an uninterrupted treatment and an interrupted treatment to obtain, respectively, the first delivered dose distribution and the second delivered dose distribution. Useful detection media include materials and devices employed in radiation dosimetry, including radiographic film 38 or three-dimensional gels (e.g., “BANG” and “BANANA” gels) which darken or change color upon exposure to radiation. Radiographic film 38 can be used either alone or as shown in FIG. 1, as one or more layers of a phantom 36. Other useful detection media include electronic portal imaging devices and amorphous silicon detector arrays, which generate a signal in response to radiation exposure. In contrast to radiographic film 38, in which separate films—or at least different areas of a single film—must be used to collect the first and second delivered dose distributions, a single electronic portal imaging device or a single amorphous silicon detector array may be used to collect both dose distributions.

The first and second dose distributions may be obtained by exposing the detection media to a test pattern, which has been input into the computer-based control system of the radiotherapy system 10 shown in FIG. 1. Alternatively, the first and second dose distributions may be obtained by exposing the detection media to an actual patient's treatment plan, which also has been input into the control system. In either case, the method 100 requires that one measure or collect at least two delivered dose distributions: one from a “normal” or uninterrupted treatment (i.e., the first delivered dose distribution) and one from the same treatment (test pattern or treatment plan) that has been interrupted one or more times (i.e., the second delivered dose distribution).

Once the first and second dose distributions have been collected, the method 100 obtains 106 first and second images. The first and second images are two- or three-dimensional digital representations of the delivered dose distributions (data arrays) that can be manipulated using a computer. Thus, each image describes the amount of radiation delivered to a particular area or volume in space. Depending on the detection media used, it may be necessary to digitize the delivered dose distributions. For example, as noted earlier radiographic film 38 darkens when exposed to ionizing radiation. The degree of darkening depends on the amount of radiation absorbed by the energy sensitive layer on the film, and can be quantified in terms of the film's optical density. After exposing the radiographic films during uninterrupted and interrupted treatments as described above, a technician develops the radiation-sensitive films and scans them with a film digitizer, which converts each of the films to an array of pixels having values representing the optical density at each point on a particular film. When using detection media that generate a digital signal in response to radiation exposure (e.g., electronic portal imaging devices and amorphous silicon detector arrays) it may be unnecessary to digitize the measured delivered dose distributions.

In many cases it may be desirable to convert the digital data (e.g., optical density measurements) to absorbed dose (cGy) using a calibration such as an H&D curve, which relates film optical density to radiation dose. It other cases, it may be desirable to use units different than absorbed dose, as long as the unit of measure chosen is consistent between the first and second delivered dose distributions. For a discussion of the use of calibration techniques to obtain absorbed dose from radiation dosimetry measurements, see International Application No. WO 01/52622 A2, “Automated Calibration Adjustment for Film Dosimetry,” published Jul. 26, 2001, the teachings of which are incorporated herein by reference in their entirety and for all purposes.

After the first and second dose distributions have been measured 102, 104, the method 100 registers 108 the resulting images to ensure that the first and second images are mapped into the same physical space. In other words, the method 100 ensures that the physical locations of the delivered dose measurements with respect to the isocenter of the radiotherapy system 10 (or some other reference point or points) are consistent between the two images. Various methods may be used to register the two images. For example, an AFFINE transform may be used to correct two-dimensional images for any shifts due to translation, rotation, or magnification differences between the images. Similarly, a Mutual Information Transform may be used to correct three-dimensional images.

Following registration 108 of the images, the method 100 compares 110 the first and second images to determine any differences between them and hence any differences between the uninterrupted and the interrupted radiation treatments. The comparison may be a simple differencing scheme:

Δ(i,j)=I₂(i,j)−I₁(i,j). I

In equation I, I is an array (two-dimensional image) containing values of the delivered dose; i and j are integers that identify individual elements of the array corresponding to different physical locations; and subscripts “1” and “2” refer to the first and second images, respectively. For a three-dimensional image or array, Equation I would contain an additional array element index, k. Besides using a differencing scheme, the method 100 may use more sophisticated comparison techniques, including correlation.

The differencing scheme shown in Equation 1 retains the spatial information of both images. However, other comparison 110 techniques may not. For example, the method 100 may calculate from both images, dose area histograms (DAHs) or cumulative dose area histograms (cDAHs) for two-dimensional images, or dose volume histograms (DVHs) or cumulative dose volume histograms (cDVHs) for three-dimensional images. The cumulative dose area or volume histograms are graphs that display, respectively, the total area or total volume of tissues treated with a particular radiation dose level during a given treatment plan. Similarly, the dose area or volume histograms are graphs that display, respectively, the area or volume distribution of the absorbed dose in tissue during delivery of a particular treatment plan. The cDVHs (cDAHs) or the DVHs (cDAHs) may be compared visually or may be subtracted from one another to determine any differences between the uninterrupted and the interrupted treatments.

The method 100 may optionally display 112 or output some quality characteristic that indicates any differences between the uninterrupted and the interrupted treatments. For example, the method 100 may present the therapist with a two or three-dimensional picture that represents the results of the differencing scheme obtained from Equation I. In such cases, different colors, different shades of grays, and the like may represent differences. Or the method 100 may present the therapist with an array of numbers, which quantify differences between the two images. The method 100 may display cDAHs, cDVHs, DAHs, or DVHs for the two images, which the therapist may compare visually. Or the method 100 may subtract a dose area histogram derived from one image from a dose area histogram derived from another image, and so on, in order to display differences between the uninterrupted and the interrupted treatment.

Based on the comparison of the two images or the evaluation of a quality characteristic derived from the two images, the radiation physicist, therapist, physician or the radiotherapy system 10 manufacturer may decide if the interrupted treatment matches the uninterrupted treatment to a sufficient degree that would permit treatment of a patient. For example, if the DVHs of the first and second images differ by less than some threshold value, e.g. five cGy over each volume increment, then the uninterrupted and the interrupted treatment would be said to match. However, if the DVHs of the first and second images differed by more than the threshold value over any of the volume increments, then the interrupted treatment and the interrupted treatment would not be considered to match.

Portions of the disclosed method 100 are typically implemented as software routines that run on a processor. Suitable processors include, for example, both general and special purpose microprocessors. Typically, the processor receives instructions and data from a read-only memory and/or a random access memory. Computer instructions and data are loaded into the read-only memory and/or the random access memory from a storage device or computer readable medium. Storage devices suitable for tangibly embodying computer program instructions and data include all forms of non-volatile memory, including, for example, semiconductor memory devices, such as EPROM, EEPROM, and flash memory devices; magnetic disks such as internal hard disks and removable disks; magneto-optical disks; and CDROM, CD-R and CD-RW disks. One may supplement any of the foregoing by, or incorporate in, ASICs (application-specific integrated circuits).

To provide interaction with a user, one may implement portions of the method 100 on a computer system having devices for displaying information to the user (e.g., therapist) and for allowing the user to input information to the computer system. Useful display devices include a monitor and LCD screen; suitable input devices include a keyboard, which can be used with a pointing device such as a pressure-sensitive stylus, a touch pad, a mouse or a trackball. In addition, the computer system may provide a graphical user interface through which the computer routines interact with the therapist.

### EXAMPLE

The following example is intended as illustrative and non-limiting, and represents a specific embodiment of the present invention.

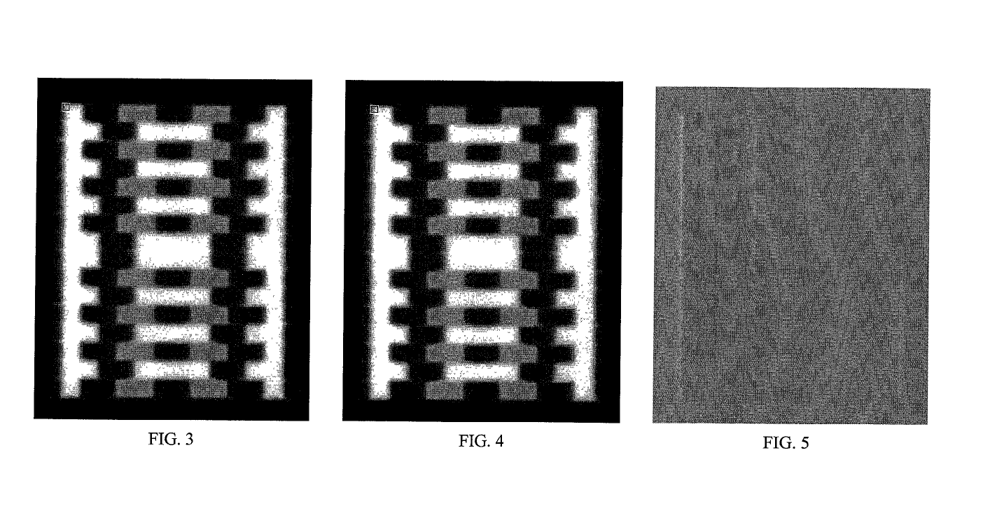

Two radiographic films were exposed to radiation from a test pattern generated by a VARLAN CLINAC® 2100 linear accelerator fitted with a 120 leaf multi-leaf collimator under substantially identical conditions except that the first test pattern was uninterrupted, whereas the second test pattern was interrupted. The two films were developed under similar conditions and then digitized. The resulting images from the first and second test patterns are shown in FIG. 3 and FIG. 4, respectively. The darkest areas on the two images correspond to the largest delivered doses of radiation (highest optical density), while the lightest areas on the two films correspond to the lowest delivered doses of radiation (lowest optical density). FIG. 5 shows an image obtained by subtracting the first image from the second image.

The above description is intended to be illustrative and not restrictive. Many embodiments and many applications besides the examples provided would be apparent to those of skill in the art upon reading the above description. The scope of the invention should therefore be determined, not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A method of performing quality assurance on an interrupted treatment of radiation therapy, the method comprising:
measuring a first delivered dose distribution during an uninterrupted treatment;
measuring a second delivered dose distribution during an interrupted treatment;
obtaining first and second images that represent the first and second delivered dose distributions, respectively;
registering the first and second images so that they substantially map into the same space; and
comparing the first and second images to determine any differences between the first and second images.

2. The method of claim 1, further comprising displaying a quality characteristic indicating the differences between the first and second images.

3. The method of claim 1, further comprising measuring the first and second delivered dose distributions by exposing a detection medium to radiation from an uninterrupted treatment and from an interrupted treatment, respectively.

4. The method of claim 3, further comprising measuring the first and second delivered dose distributions by exposing the detection medium to a test pattern.

5. The method of claim 3, further comprising measuring the first and second delivered dose distributions by exposing the detection medium to a treatment plan of a patient.

6. The method of claim 1, further comprising obtaining the first and second images by digitizing the first and second delivered dose distributions, respectively.

7. The method of claim 1, further comprising registering the first and second images using an AFFINE transform.

8. The method of claim 1, further comprising comparing the first and second images by subtracting the first image from the second image.

9. The method of claim 1, further comprising comparing the first and second images by calculating dose area distributions from the first and second images.

10. The method of claim 9, further comprising subtracting the dose area distribution of the first image from the dose area distribution of the second image.

11. The method of claim 1, further comprising comparing the first and second images by calculating dose volume distributions from the first and second images.

12. The method of claim 11, further comprising subtracting the dose volume distribution of the first image from the dose volume distribution of the second image.

13. The method of claim 1, further comprising comparing the first and second images by calculating cumulative dose area distributions from the first and second images.

14. The method of claim 13, further comprising subtracting the cumulative dose area distribution of the first image from the cumulative dose area distribution of the second image.

15. The method of claim 1, further comprising comparing the first and second images by calculating cumulative dose volume distributions from the first and second images.

16. The method of claim 15, further comprising subtracting the cumulative dose volume distribution of the first image from the cumulative dose volume distribution of the second image.

17. A device for performing quality assurance on an interrupted treatment of radiation therapy, the device comprising a software routine tangibly embodied on a computer-readable medium and configured to generate a quality characteristic indicating differences between an uninterrupted treatment and an interrupted treatment, the software routine generating the quality characteristic from first and second images, the first and second images derived, respectively, from measurements of a first delivered dose distribution obtained during an uninterrupted treatment and a second delivered dose distribution obtained during an interrupted treatment.

18. A system for performing quality assurance on an interrupted treatment of radiation therapy, the system comprising a computer having a graphical user interface enabling a user to interact with a software routine running on the computer, the software routine configured to generate a quality characteristic indicating differences between an uninterrupted treatment and an interrupted treatment, the software routine generating the quality characteristic from first and second images, the first and second images derived, respectively, from measurements of a first delivered dose distribution obtained during an uninterrupted treatment and a second delivered dose distribution obtained during an interrupted treatment.
